(19) United States
(12) Patent Application Publication
(10) Pub. No.: US 2006/0242126 A1
(43) Pub. Date: Oct. 26, 2006

(54) System and method for a context-sensitive extensible plug-in architecture

(76) Inventor: Andrew Fitzhugh, Menlo Park, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/165,727

(22) Filed: Jun. 24, 2005

Related U.S. Application Data
(63) Continuation-in-part of application No. 11/090,409, filed on Mar. 25, 2005.

(51) Int. Cl. G06F 17/30; G06F 7/00

(52) U.S. Cl. 707/3

(57) ABSTRACT

A system and method for a context-sensitive extensible plug-in architecture. Specifically, an extensible plug-in architecture is described. The plug-in architecture includes a main application responding to at least one media object under a current context. A plug-in application is also included that extends capabilities of the main application. The plug-in architecture also includes an interface for sharing the current context with the plug-in application so that the plug-in application responds to the at least one media object under the current context.

### CROSS REFERENCE TO RELATED APPLICATIONS

This application claims priority to and is a continuation in part of the co-pending patent application, Ser. No. 11/090,409, entitled “Media-Driven Browsing,” filed on Mar. 25, 2005, to Andrew Fitzhugh, and assigned to the assignee of the present invention, the disclosure of which is hereby incorporated in its entirety by reference.

### BACKGROUND OF THE INVENTION

1. Field of the Invention

The present invention relates to the field of plug-in architectures. More specifically, the present invention relates to a context-sensitive plug-in architecture that is extensible.

2. Related Art

Individuals and organizations are rapidly accumulating large and diverse collections of media, including text, audio, graphics, animated graphics and full-motion video. This content may be presented individually or combined in a wide variety of different forms, including documents, presentations, music, still photographs, commercial videos, home movies, and metadata describing one or more associated media files. As these collections grow in number and diversity, individuals and organizations increasingly will require systems and methods for organizing and browsing the media in their collections. To meet this need, a variety of different systems and methods for browsing media have been proposed, including systems and methods for content-based media browsing and meta-data-based media browsing.

In addition to information in their own collections, individuals and organizations are able to access an ever-increasing amount of information that is stored in a wide variety of different network-based databases. For example, the internet provides access to a vast number of databases. Web pages are one of the most common forms of internet content is provided by the world-wide web (the “Web”), which is an internet service that is made up of server-hosting computers known as “Web servers”. A Web server stores and distributes Web pages, which are hypertext documents that are accessible by Web browser client programs. Web pages are transmitted over the Internet using the HTTP protocol.

Search engines enable users to search for web page content that is available over the internet. Search engines typically query searchable databases that contain indexed references (i.e., Uniform Resource Locators (URL5)) to Web pages and other documents that are accessible over the internet. In addition to URLs, these databases typically include other information relating to the indexed documents, such as keywords, terms occurring in the documents, and brief descriptions of the contents of the documents. The indexed databases relied upon by search engines typically are updated by a search program (e.g., “web crawler,” “spider,” “ant,” “robot,” or “intelligent agent”) that searches for new Web pages and other content on the Web. New pages that are located by the search program are summarized and added to the indexed databases.

Search engines allow users to search for documents that are indexed in their respective databases by specifying keywords or logical combinations of keywords. The results of a search query typically are presented in the form of a list of items corresponding to the search query. Each item typically includes a URL for the associated document, a brief description of the content of the document, and the date of the document. The search results typically are ordered in accordance with relevance scores that measure how closely the listed documents correspond to the search query.

Hitherto, media browsers and search engines have operated in separate domains: media browsers enable users to browse and manage their media collections, whereas search engines enable users to perform keyword searches for indexed information that in many cases does not include the users' personal media collections. What is needed is a media-driven browsing approach that leverages the services of search engines to enable users to serendipitously discover information related to the media in their collections.

### SUMMARY OF THE INVENTION

A system and method for a context-sensitive extensible plug-in architecture. Specifically, an extensible plug-in architecture is described. The plug-in architecture includes a main application responding to at least one media object under a current context. A plug-in application is also included that extends capabilities of the main application. The plug-in architecture also includes an interface for sharing the current context with the plug-in application so that the plug-in application responds to the at least one media object under the current context.

### BRIEF DESCRIPTION OF DRAWINGS

FIG. 1 is a diagrammatic view of an embodiment of a media-driven browser that is connected to a set of local media files, multiple sets of remote media objects, and multiple search engines.

FIG. 2 is a diagrammatic view of an embodiment of a computer system that is programmed to implement the media-driven browser shown in FIG. 1.

FIG. 3 is a diagrammatic view of an embodiment of a graphical user interface displaying a set of thumbnail images selected from a hierarchical tree.

FIG. 4 is a diagrammatic view of an embodiment of a graphical user interface displaying a high-resolution image corresponding to a selected thumbnail image.

FIG. 5 is a diagrammatic view of an embodiment of a graphical user interface displaying on a map the geographical locations associated with a selected set of image media objects.

FIG. 6 is a diagrammatic view of an embodiment of a graphical user interface presenting information that is derived from results of a context-sensitive search.

FIG. 7 is a flow diagram of an embodiment of a media-driven browsing method.

FIG. 8 shows data flow through a first portion of an implementation of the media-driven browser shown in FIG. 1.

FIG. 9 shows data flow through a second portion of the implementation of the media-driven browser shown in FIG. 8.

FIG. 10 shows data flow through a third portion of the implementation of the media-driven browser shown in FIG. 8.

FIG. 11 is a block diagram of an extensible plug-in architecture 1100, in accordance with one embodiment of the present invention.

FIG. 12 is a diagram illustrating a display window 1200 showing the implementation of the plug-in application on a media object for a particular context.

FIG. 13 is a flow chart 1300 illustrating steps in a computer implemented method for extending a context-sensitive plug-in architecture, in accordance with one embodiment of the present invention.

FIG. 14 is a diagram of a window 1400 illustrating the implementation of plug-in applications within a main application through an interface, in accordance with one embodiment of the present invention.

### DETAILED DESCRIPTION OF THE INVENTION

Reference will now be made in detail to the preferred embodiments of the present invention, a system and method for context-sensitive plug-in architectures, examples of which are illustrated in the accompanying drawings. While the invention will be described in conjunction with the preferred embodiments, it will be understood that they are not intended to limit the invention to these embodiments. On the contrary, the invention is intended to cover alternative, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, and components have not been described in detail as not to unnecessarily obscure aspects of the present invention.

Notation and Nomenclature

Some portions of the detailed descriptions, which follow, are presented in terms of procedures, steps, logic blocks, processing and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as transactions bits, values, elements, symbols, characters, fragments, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention discussions utilizing the terms such as “performing,” or “presenting,” or “sharing,” or “responding,” or “changing,” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission or display devices. The present invention is well suited to the use of other computer systems.

Overview

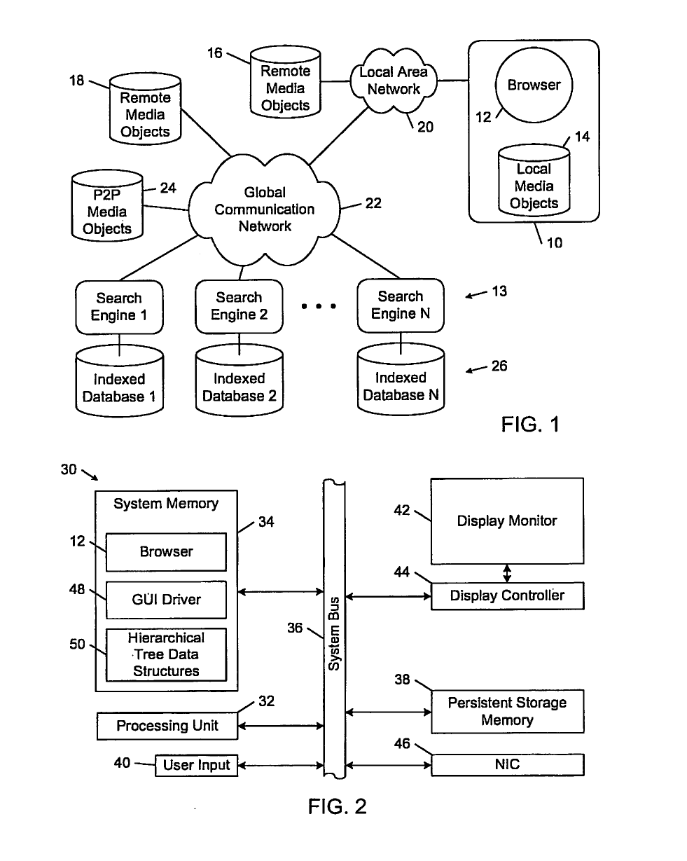

FIG. 1 shows an embodiment of a network node 10 that includes a media-driven browser 12 that enables users to serendipitously discover information related to media objects in their collections by leveraging the functionalities of a number of search engines 13. As explained in detail below, the media-driven browser 12 automatically obtains information related to one or more selected media objects by performing targeted searches based at least in part on information associated with the selected media objects. In this way, the media-driven browser 12 enriches and enhances the context in which users experience the media objects in their collections.

The media objects in a user's collection may be stored physically in a local database 14 of the network node 10 or in one or more remote databases 16, 18 that may be accessed over a local area network 20 and a global communication network 22, respectively. The media objects in the remote database 18 may be provided by a service provider free-of-charge or in exchange for a per-item fee or a subscription fee. Some media objects also may be stored in a remote database 24 that is accessible over a peer-to-peer (P2P) network connection. As used herein, the term “media object” refers broadly to any form of digital content, including text, audio, graphics, animated graphics, full-motion video and electronic proxies for physical objects. This content is implemented as one or more data structures that may be packaged and presented individually or in some combination in a wide variety of different forms, including documents, annotations, presentations, music, still photographs, commercial videos, home movies, and metadata describing one or more associated digital content files. As used herein, the term “data structure” refers broadly to the physical layout (or format) in which data is organized and stored.

In some embodiments, digital content may be compressed using a compression format that is selected based upon digital content type (e.g., an MP3 or a WMA compression format for audio works, and an MPEG or a motion JPEG compression format for audio/video works). Digital content may be transmitted to and from the network node 10 in accordance with any type of transmission format, including a format that is suitable for rendering by a computer, a wireless device, or a voice device. In addition, digital content may be transmitted to the network node 10 as a complete file or in a streaming file format. In some cases transmissions between the media-driven browser 12 and applications executing on other network nodes may be conducted in accordance with one or more conventional secure transmission protocols.

The search engines 13 respond to queries received from the media-driven browser 12 by querying respective databases 26 that contain indexed references to Web pages and other documents that are accessible over the global communication network 22. The queries may be atomic or in the form of a continuous query that includes a stream of input data. The results of continuous queries likewise may be presented in the form of a data stream. Some of the search engines 13 provide specialized search services that are narrowly tailored for specific informational domains. For example, the MapPoint® Web service provides location-based services such as maps, driving directions, and proximity searches, the Delphion™ Web service provides patent search services, the BigYellow™ Web service provides business, products and service search services, the Tucows Web services provides software search services, the CareerBuilder.com™ Web service provides jobs search services, and the MusicSearch.com™ Web service provides music search services. Other ones of the search engines 13, such as Google™, Yahoo™, AltaVista™, Lycos™, and Excite™, provide search services that are not limited to specific informational domains. Still other ones of the search engines 13 are meta-search engines that perform searches using other search engines. The search engines 13 may provide access to their search services free-of-charge or in exchange for a fee.

Global communication network 22 may include a number of different computing platforms and transport facilities, including a voice network, a wireless network, and a computer network (e.g., the internet). Search queries from the media-driven browser 12 and search responses from the search engines 13 may be transmitted in a number of different media formats, such as voice, internet, e-mail and wireless formats. In this way, users may access the search services provided by the search engines 13 using any one of a wide variety of different communication devices. For example, in one illustrative implementation, a wireless device (e.g., a wireless personal digital assistant (PDA) or cellular telephone) may connect to the search engines 13 over a wireless network. Communications from the wireless device may be in accordance with the Wireless Application Protocol (WAP). A wireless gateway converts the WAP communications into HTTP messages that may be processed by the search engines 13. In another illustrative implementation, a software program operating at a client personal computer (PC) may access the services of search engines over the internet.

Architecture

Referring to FIG. 2, in one embodiment, the media-driven browser 12 may be implemented as one or more respective software modules operating on a computer 30. Computer 30 includes a processing unit 32, a system memory 34, and a system bus 36 that couples processing unit 32 to the various components of computer 30. Processing unit 32 may include one or more processors, each of which may be in the form of any one of various commercially available processors. System memory 34 may include a read-only memory (ROM) that stores a basic input/output system (BIOS) containing start-up routines for computer 30 and a random access memory (RAM). System bus 36 may be a memory bus, a peripheral bus or a local bus, and may be compatible with any of a variety of bus protocols, including PCI, VESA, Microchannel, ISA, and EISA. Computer 30 also includes a persistent storage memory 38 (e.g., a hard drive, a floppy drive, a CD ROM drive, magnetic tape drives, flash memory devices, and digital video disks) that is connected to system bus 36 and contains one or more computer-readable media disks that provide non-volatile or persistent storage for data, data structures and computer-executable instructions. A user may interact (e.g., enter commands or data) with computer 30 using one or more input devices 40 (e.g., a keyboard, a computer mouse, a microphone, joystick, and touch pad). The media-driven browser 12 presents information to and receives information from a user through a graphical user interface (GUI) that is displayed to the user on a display monitor 42, which is controlled by a display controller 44. Computer 30 also may include peripheral output devices, such as speakers and a printer. One or more remote computers may be connected to computer 30 through a network interface card (NIC) 46.

As shown in FIG. 2, system memory 34 also stores the media-driven browser 12, a GUI driver 48, and one or more hierarchical tree data structures 50, which may be stored, for example, in an XML (extensible Markup Language) file format. The media-driven browser 12 interfaces with the GUI driver 48 and the user input 40 to respond to user commands and selections. The media-driven browser 12 also interfaces with the GUI driver 48 and the hierarchical tree data structures 50 to control the browsing experience that is presented to the user on display monitor 42. The media objects in the collection to be browsed may be stored locally in persistent storage memory 38 or stored remotely and accessed through NIC 46, or both.

User Interface

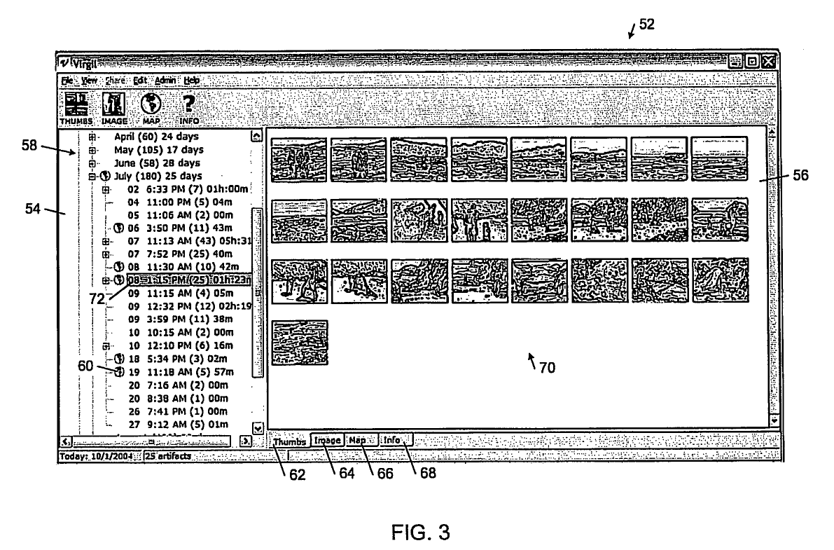

FIG. 3 shows an embodiment of a graphical user interface 52 through which the media-driven browser 12 presents information to and receives information from a user.

A user initializes the media-driven browser 12 by selecting a command that causes the media-driven browser 12 to automatically scan for one or more different types of media objects in one or more default or specified local or remote file locations. The set of media objects that is identified by the media-driven browser 12 constitutes an active media object collection. The active media object collection may be changed by adding or removing media objects from the collection in accordance with user commands. During the scanning process, the media-driven browser 12 computes thumbnail representations of the media objects and extracts metadata and other parameters that are associated with the media objects.

Once the media-driven browser 12 has been initialized, the graphical user interface 52 presents information related to the active collection of media objects in two primary areas: a hierarchical tree pane 54 and a presentation pane 56.

The hierarchical tree pane 54 presents clusters of the media objects in the collection organized into a logical tree structure, which correspond to the hierarchical tree data structures 50. In general, the media objects in the collection may be clustered in any one of a wide variety of ways, including by spatial, temporal or other properties of the media objects. The media objects may be clustered using, for example, k-means clustering or some other clustering method. In the illustrated embodiment, the media-driven browser 12 clusters the media objects in the collection in accordance with timestamps that are associated wit the media objects, and then presents the clusters in a chronological tree structure 58. The tree structure 58 is organized into a hierarchical set of nested nodes corresponding to the year, month, day, and time of the temporal metadata associated with the media objects, where the month nodes are nested under the corresponding year nodes, the day nodes are nested under the corresponding month nodes, and the time nodes are nested under the corresponding day nodes. Each node in the tree structure 58 includes a temporal label indicating one of the year, month, day, and time, as well as a number in parentheses that indicates the number of media objects in the corresponding cluster. The tree structure 58 also includes an icon 60 (e.g., a globe in the illustrated embodiment) next to each of the nodes that indicates that one or more of the media objects in the node includes properties or metadata from which one or more contexts may be created by the media-driven browser 12. Each node also includes an indication of the duration spanned by the media objects in the corresponding cluster.

The presentation pane 56 presents information that is related to one or more media objects that are selected by the user. The presentation pane 56 includes four tabbed views: a “Thumbs” view 62, an “Images” view 64, a “Map” view 66, and an “Info” view 68. Each of the tabbed views 62-68 presents a different context that is based on the cluster of images that the user selects in the hierarchical tree pane 54.

The Thumbs view 62 shows thumbnail representations 70 of the media objects in the user-selected cluster. In the exemplary implementation shown in FIG. 3, the selected cluster is the twenty-five member, July 8th cluster 72, which is highlighted in the hierarchical tree pane 54. In the illustrated embodiment, each of the media objects in the selected cluster 72 is a digital image and each of the thumbnail representations 70 presented in the Thumbs view 62 is a reduced-resolution thumbnail image of the corresponding media object. Other media objects may have different thumbnail representations 70. For example, a video media object may be represented by a thumbnail image of the first keyframe that is extracted from the video media object. A text document may be represented by a thumbnail image of the first page of the document. An audio media object may be represented by an audio icon along with one or more keywords that are extracted form the audio media object. In the illustrated embodiment, the thumbnail representations 70 are presented chronologically in the presentation pane 56. In other embodiments, the user may sort the thumbnail representations 70 in accordance with one or more other properties or metadata (e.g., geographical data) that are associated with the media objects in the collection.

In some implementations, a user can associate properties with the media objects in the selected cluster 72 by dragging and dropping text, links, or images onto the corresponding thumbnail representations. In addition, the user may double-click a thumbnail representation 70 to open the corresponding media object in a full-screen viewer. Once in the full-screen viewer, the user may view adjacent media objects in the full-screen viewer by using, for example, the left and right arrow keys.

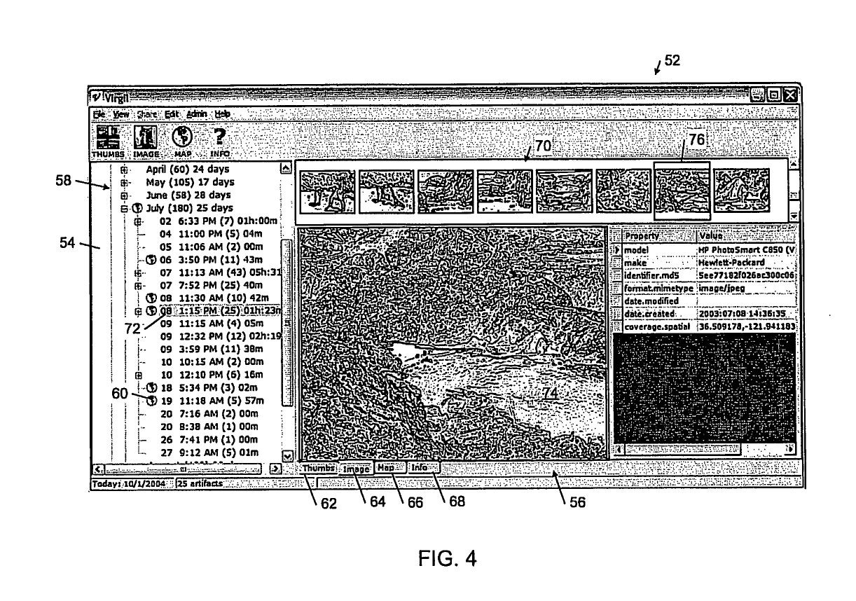

Referring to FIG. 4, the Image view 64 shows at the top of the presentation pane 56 a single row of the thumbnail representations 70 in the selected media object cluster 72. The image view 64 also shows an enlarged, higher-resolution view 74 of a selected media object corresponding to a selected one 76 of the thumbnail representations 70, along with a list of properties that are associated with the selected media object. Among the exemplary media object properties that are associated with the selected media object are:
model: the model of the device used to create the media object
make: the make of the device
identifier: an identifier (e.g., a fingerprint or message digest derived from the media object using a method, such as MD5) assigned to the media object
format.mimetype: a format identifier and a Multipart Internet Mail Extension type corresponding to the media object
date.modified: the last modification date of the media object
date.created: the creation date of the media object
coverage.spatial: geographical metadata associated with the media object

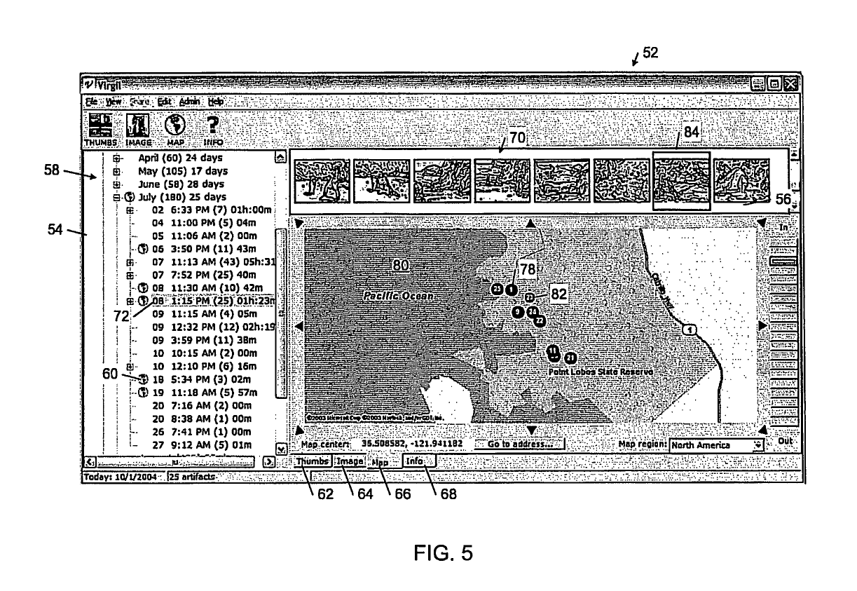

Referring to FIG. 5, the Map view 66 shows at the top of the presentation pane 56 a single row of the thumbnail representations 70 in the selected media object cluster 72. The Map view 64 also shows geo-referenced ones of the media objects in the selected cluster 72 (i.e., the media objects in the selected cluster 72 that are associated with geographical metadata) as numbered circles 78 on a zoom and pan enabled map 80. The numbers in the circles 78 indicate the temporal order of the geo-referenced media objects. When a user selects one of the circles 78 (e.g., circle 82), the media-driven browser 12 highlights the selected circle 82, scrolls to the corresponding thumbnail representation 70, and highlights the corresponding thumbnail representation 70 (e.g., with an encompassing rectangle 84). The user may assign a location to a selected one of the media objects, by centering the map 80 on the location and selecting an Assign Location command, which is available on the Edit drop down menu. In some implementations, geographical metadata may be associated with the media objects in the selected cluster 72 by importing data from a GPS tracklog that was recorded while the media objects were being created. The recorded GPS data may be associated with corresponding ones of the media objects in any one of a wide variety of ways (e.g., by matching timestamps that are associated with the media objects to timestamps that were recorded with the GPS data). Selecting the “Go to address” button causes the media-driven browser 12 to pan to a location specified by entering a full or partial street address.

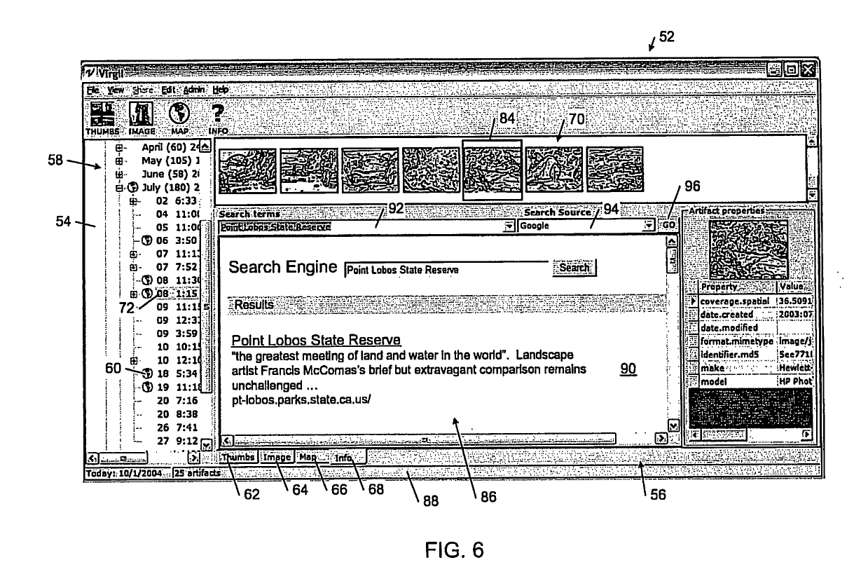

Referring to FIG. 6, the Info view 68 shows at the top of the presentation pane 56 a single row of the thumbnail representations 70 in the selected media object cluster 72, along with a list of properties (“Artifact properties”) that are associated with the media object corresponding to a selected one 84 of the thumbnail representations 70. The Info view 64 also shows context-sensitive information 86 relating to the selected media object that is obtained by leveraging the functionalities of the search engines 13, as explained in section IV below. The selected media object corresponds to either the media object corresponding to the selected thumbnail representation 84 or, if none of the thumbnail representations 70 has been selected, a default summary object that represents the cluster. The default summary object may be generated from the objects in the selected cluster either automatically or in response to a user command. If none of the media objects in the selected cluster has been selected or there is no default summary object, the user is notified that a context could not be created by a message in a status bar 88. Alternatively, the media-driven browser 12 may suggest one or more of the media objects in the selected cluster 72 as candidates for the selected media object.

The context-sensitive information 86 is presented in a search pane 90 that includes a “Search terms” drop down menu 92 and a “Search Source” drop down menu 94. The Search terms drop down menu 92 includes a list of context-sensitive search queries that are generated by the media-driven browser 12 and ordered in accordance with a relevance score. The Search Source drop down menu 94 specifies the source of the context-sensitive information that is retrieved by the media-driven browser 12. Among the exemplary types of sources are general-purpose search engines (e.g., Google™, Yahoo™, AltaVista™, Lycos™, and Excite™) and specialized search engines (e.g., MapPoint®, Geocaching.com™, Delphion™, BigYellow™, Tucows, CareerBuilder.com™, and MusicSearch.com™). The Search Sources are user-configurable and can be configured to perform searches based on media object metadata (including latitude/longitude) using macros. In some cases, the {TERMS} macro may be used to automatically insert the value of the Search terms in the search query input of the selected search engine may be used to insert the latitude and longitude of the current media object). Search sources that do not include the {TERMS} macro will ignore the current Search terms value. Searches are executed automatically when the selected media object is changed, the selected time cluster is changed, the Info tab 68 is selected, when the Search terms 92 or Search Source 94 selections are changed, and when the GO button 96 is selected. The Search terms selection can be modified to improve the search results. For example, some point-of-interest names, like “Old City Hall’, are too general. In this case, the search terms may be refined by adding one or more keywords (e.g., “Philadelphia”) to improve the search results.

Media-Driven

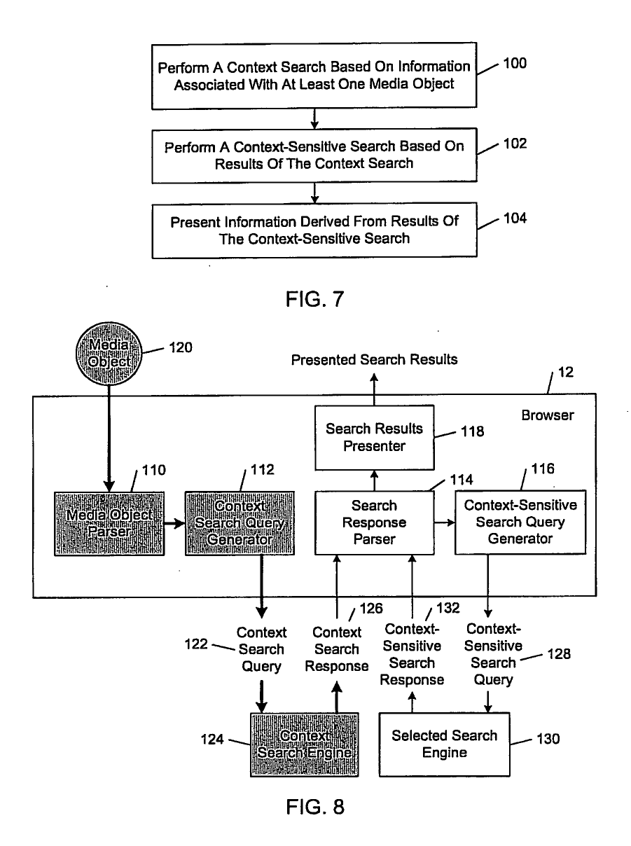

As explained in detail below, the media-driven browser 12 is a contextual browser that presents contexts that are created by information that is related to selected ones of the media objects in a collection. FIG. 7 shows an embodiment of a method by which the media-driven browser 12 creates the contexts that are presented in the Info view 68 of the graphical user interface 52.

The media-driven browser 12 performs a context search based on information that is associated with at least one media object (block 100). In general, the media-driven browser 12 identifies the related contextual information based on information that is associated with the media objects, including intrinsic features of the media objects and metadata that is associated with the media objects. In this regard, the media-driven browser 12 extracts information from the media object and generates a context search query from the extracted information. The media-driven browser 12 transmits the context query search to at least one of the search engines 13. In some implementations, the context query search is transmitted to ones of the search engines 13 that specialize in the informational domain that is most relevant to the criteria in the context query search. For example, if the context query search criteria relates to geographical information, the context query search may be transmitted to a search engine, such as MapPoint® or Geocaching.com™, that is specially tailored to provide location-related information. If the context query search criteria relates to music, the context query search may be transmitted to a search engine, such as MusicSearch.com™, that is specially tailored to provide music-related information. In other implementations, the context query search may be transmitted to one or more general-purpose search engines.

Based on the results of the context search (block 100), the media-driven browser 12 performs a context-sensitive search (block 102). In this regard, the media-driven browser 12 generates a context-sensitive search query from the results of the context search and transmits the context-sensitive search query to one or more of the search engines 13. The ones of the search engines 13 to which the context-sensitive search query are transmitted may be selected by the user using the Search Source 94 drop down menu or may be selected automatically by the media-driven browser 12.

The media-driven browser 12 then presents information that is derived from the results of the context-sensitive search in the Info view 68 of the graphical user interface 52 (block 104). In this regard, the media-driven browser 12 may reformat the context-sensitive search response that is received from the one or more search engines 13 for presentation in the Info view 68. Alternatively, the media-driven browser 12 may compile the presented information from the context-sensitive search response. In this process, the media-driven browser 12 may perform one or more of the following operations: re-sort the items listed in the search response, remove redundant items from the search response, and summarize one or more items in the search response.

FIGS. 8, 9, and 10 show the data flow through an implementation of the media driven browser 12 during execution of the media-driven browsing method of FIG. 7. In this implementation, the media driven browser includes a media object parser 110, a context search query generator 112, a search response parser 114, a context-sensitive search query generator 116, and a search results presenter 118. In general, these components are not limited to any particular hardware or software configuration, but rather they may be implemented in any computing or processing environment, including in digital electronic circuitry or in computer hardware, firmware, or software In some embodiments, these components are implemented by a computer process product that is tangibly embodied in a machine-readable storage device for execution by a computer processor. The method of FIG. 7 may be performed by a computer processor executing instructions organized, for example, into the process modules 110-118 that carry out the steps of this method by operating on input data and generating output.

The data flow involved in the process of performing the context search (block 100; FIG. 7) is shown highlighted in FIG. 8.

In this process, the media object parser 110 extracts information from a media object 120. In some implementations, the extracted information may relate at least one of intrinsic properties of the media object 120, such as image features (e.g., if the media object 120 includes an image) or text features (e.g., if the media object 120 includes text), and metadata associated with the media object 120. In these implementations, the media object parser 110 includes one or more processing engines that extract information from the intrinsic properties of the media object. For example, the media object parser 110 may include an image analyzer that extracts color-distribution metadata and from image-based media objects or a machine learning and natural language analyzer that extracts keyword metadata from document-based media objects. In some implementations, the extracted information may be derived from metadata that is associated with the media object 120, including spatial, temporal and spatiotemporal metadata (or tags) that are associated with the media object 120. In these implementations, the media object parser 110 includes a metadata analysis engine that can identify and extract metadata that is associated with the media object 120.

The media object parser 110 passes the information that is extracted from the media object 120 to the context search query generator 112. In some implementations, the context search query generator 112 also may receive additional information, such as information relating to the current activities of the user. The context search query generator 112 generates the context search query 122 from the information that is received. In this process, the context search query generator 112 compiles the context search query 122 from the received information and translates the context search query into the native format of a designated context search engine 124 that will be used to execute the context search query 122. The translation process includes converting specific search options into the native syntax of the context search engine 124.

The context search engine 124 identifies in its associated indexed database items corresponding to the criteria specified in the context search query 122. The context search engine 124 then returns to the media-driven browser 12 a context search response 126 that includes a list of each of the identified items, along with a URL, a brief description of the contents, and a date associated with each of the listed items.

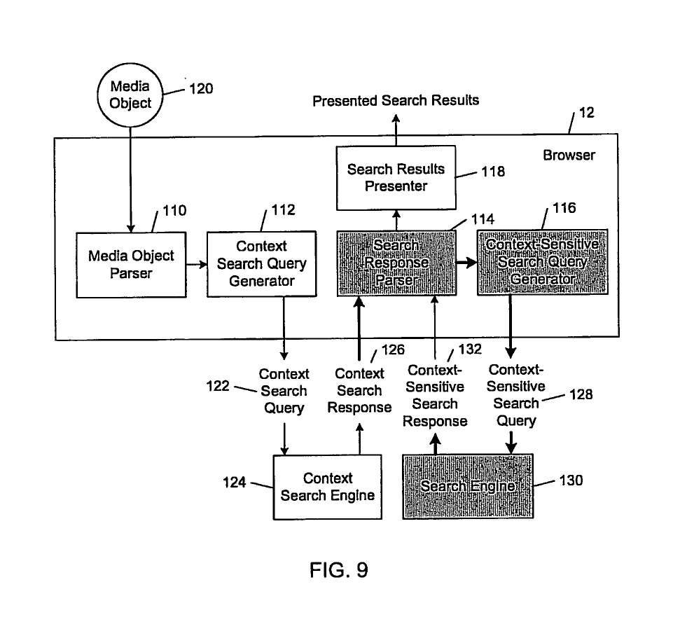

The data flow involved in the process of performing the context-sensitive search (block 102; FIG. 7) is shown highlighted in FIG. 9. The search response parser 114 receives the context search response 126 from the context search engine 124. The search response parser 114 then extracts information from the context search response 126. In this process, the search response parser 114 separates the results of the context search from other items that might be incorporated in the context search response 126, including advertisements and other extraneous information.

The search response parser 114 passes the information extracted from the context search response 126 to the context-sensitive search query generator 116. The context-sensitive search query generator 116 generates a context-sensitive search query 128 from the extracted information received from the search response parser 114. In this process, the context-sensitive search query generator 116 compiles the context-sensitive search query 128 from the extracted information and translates the context-sensitive search query 128 into the native format of a selected search engine 130 that will be used to execute the context-sensitive search query 128. The translation process includes converting specific search options into the native syntax of the selected search engine 130.

The context-sensitive search engine 130 identifies in its associated indexed database items corresponding to the criteria specified in the context-sensitive search query 128. The context-sensitive search engine 130 then returns to the media-driven browser 12 a context-sensitive search response 132 that includes a list of each of the identified items, along with a URL, a brief description of the contents, and a date associated with each of the listed items.

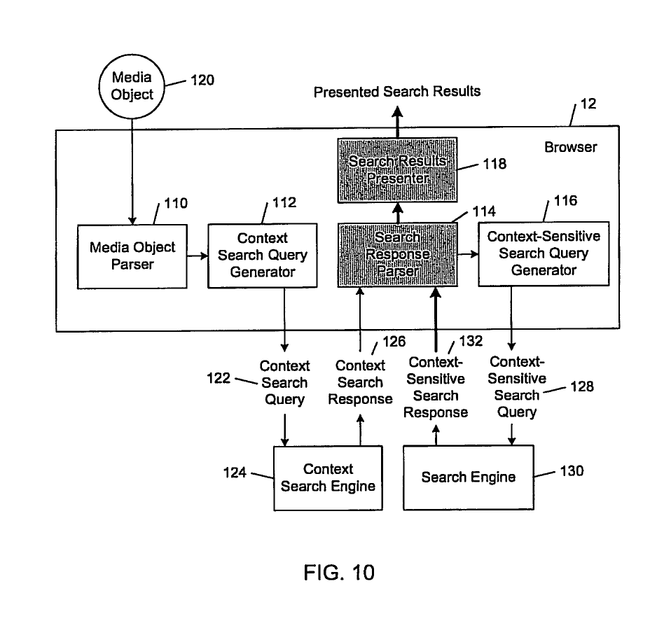

The data flow involved in the process of presenting information derived from results of the context search (block 104; FIG. 7) is shown highlighted in FIG. 10. The search response parser 114 receives the context-sensitive search response 132 from the selected search engine 130. The search response parser 114 then extracts information from the context-sensitive search response 132. In this process, the search response parser 114 separates the results of the context-sensitive search from other items that might be incorporated in the context-sensitive search response 132, including advertisements and other extraneous information.

The search response parser 114 passes the information extracted from the context-sensitive search response 132 to the search results presenter 118. The search results presenter 118 presents information that is derived from the results of the context-sensitive search in the Info view 68 of the graphical user interface 52. In this regard, the search results presenter 118 may reformat the extracted components of context-sensitive search response 132 and present the reformatted information in the Info view 68. Alternatively, the search results presenter 118 may compile the presentation information from the extracted components of the context-sensitive search response 132. In this process, the search results presenter 118 may perform one or more of the following operations: re-sort the extracted components; remove redundant information; and summarize one or more of the extracted components.

In some implementations, the search results presenter 118 presents in the Info view 68 only a specified number of the most-relevant ones of extracted components of the context-sensitive search response 132, as determined by relevancy scores that are contained in the context-sensitive search response 132. In some implementations, the search results presenter 118 may determine a set of relevancy scores for the extracted components of the context-sensitive search response 132. In this process, the search results presenter 118 computes feature vectors for the media object and the extracted components. The media object feature vector may be computed from one or more intrinsic features or metadata that are extracted from the media object 120. The search results presenter 118 may determine relevancy scores for the extracted components of the context-sensitive search response 132 based on a measure of the distance separating the extracted component feature vectors from the media object feature vector. In these implementations, any suitable distance measure (e.g., the L squared norm for image-based media objects) may be used.

In other implementations, the search results presenter 118 presents in the Info view 68 only those extracted components of the context-sensitive search response 132 with feature vectors that are determined to be within a threshold distance of the feature vector computed for the media object 120.

Context-Sensitive Plug-In Architecture That is Extensible

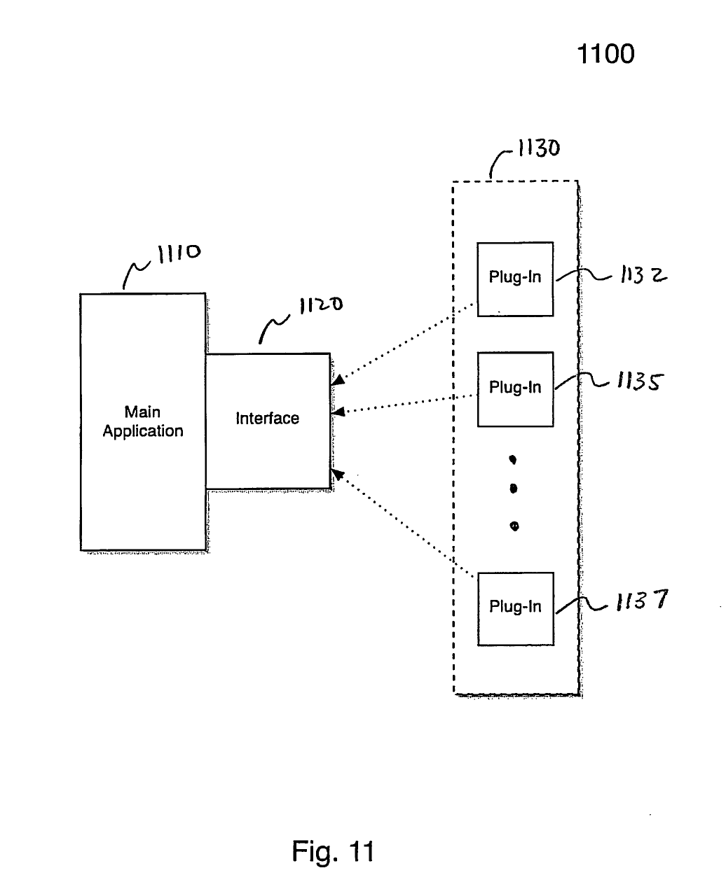

FIG. 11 is a block diagram of an extensible plug-in architecture 1100, in accordance with one embodiment of the present invention. More particularly, the extensible plug-in architecture 1100 provides a framework in which plug-in applications perform using context-sensitive information.

The plug-in architecture 1100 includes a main application 1110 that responds to at least one media object under a current context. For instance, in one embodiment, the main application 1110 is a media browser. In another embodiment, the main application 1110 is an information browser. For example, the information browser supports various data formats, such as video, e-mail, other electronic documents, etc. For instance, in one exemplary embodiment, the main application is a photo browser application that presents a personal photo collection. For instance the photo browser application can present and organize personal photos as shown in FIG. 3.

Also shown in FIG. 11 is a plurality of plug-in applications 1130. The plurality of plug-in applications 1130 includes plug-in application 1132, plug-in application 1135, on up to the n-th plug-in application 1137. Each of the plug-in applications in the plurality of plug-in applications 1130 extend the capabilities of the main application 1110. That is, the plug-in application provides additional features to the main application 1110. For instance, plug-in applications as previously mentioned, such as various search engines that provide related information from the internet, and mapping applications that map related locations associated with the media object, provide further functionality to the main application 1110.

In one embodiment, each of the plurality of plug-in applications 1130 are implemented using dynamically linked libraries (DLLs) on the local computing device. In another embodiment, a distributed computing implementation of the plug-in architecture is provided. More specifically, one or more of the plurality of plug-in applications 1130 are provided on remote computing devices, and are accessible to the main application on the local computing device through the plug-in interface.

The plug-in architecture 1100 also includes at least one interface 1120 between the main application and the plurality of plug-ins 1130. The interface provides compatibility between the main application 1110 and each of the plurality of plug-in applications 1130. Rather than directly supporting each of the plug-in applications within the main application 1110, the present embodiment is able to incorporate the functionality of each of the plurality of plug-in applications 1130 through the common interface.

That is, by using the interface 1120, each of the plurality of plug-in applications 1130 can provide additional information and functionality to the main application 1110 in a manner that is compatible with the interface 1120 and understood by the main application. In one embodiment, application programming interface (API) hooks are provided within the plug-in applications that are understood by the main application 1110 through the interface 1120. As such, the API hooks are able to define actions or functions that are called. In addition, the API hooks also provide information associated with the plug-in application, such as the name of the plug-in application.

More specifically, the interface 1120 is capable of sharing the current context with each of the plurality of plug-in applications 1130. In that way, each of the plug-in applications is able to respond to the at lease one media object using the current context. As such, the interface 1120 provides an architecture that allows the main application 1110 and each of the plurality of plug-ins 130 to share the current context within each of the applications for use in their operation.

For instance, as an exemplary example, within a main application that is an information browser, data (e.g., a personal photo collection) in the main application is enhanced through the use of contextual information as provided to various plug-in applications. For instance, a context of time and location are provided to plug-in applications when browsing the personal photo collection. As such, plug-in applications are capable of generating different information depending on the current context. For instance, for a particular current context, one plug-in application my plot the photos of media objects as point on a map. Also, another plug-in application may present web links related to the current photos. In addition, another plug-in application may present a view of different photos from the same time period and/or place that exists on an online photo service. For instance, the related photos may be from a friend taking the same trip.

Other embodiments of the present invention support other contexts as applied by the plug-in applications, such as personal identity, temperature, pollen count, population density, etc. Basically, embodiments of the present invention are able to support existing and future contexts as applied by the plug-in applications.

In addition, in another embodiment, the interface 1120 also is able to communicate any changes in the current context that are made by the main application 1110, or by any of the plurality of plug-in applications 1130. As such, the information provided by the main application and each of the plurality of plug-in applications 1130 is sensitive to the current context shared by all of the applications.

For example, the interface 1120 is able to provide the current context to the plug-in application 1132 so that the plug-in application 1132 is able to respond to the at least one media object under the current context. In addition, the present embodiment is able to support a second plug-in application, such as plug-in application 1135, for extending the capabilities of the main application 1110. As such, the interface is capable of sharing the current context with the plug-in application 1135 so that the plug-in application is also able to respond to the at least one media object under the current context. As a result, the present embodiment provides a plug-in architecture that allows a user to navigate through time, location, and persons as identified by personal identity context information, and switch between different plug-in applications while maintaining a consistent state of context.

In one embodiment, the current context as previously described can define a date and time, or time period, a location, or personal identity. For example, within the environment of an information browser, (e.g., photo browser), the date and time can define a time within which a group of photographs were taken. Also, the location context associated with the media object can define a region or location where a group of photographs were taken. The personal identity context can define who in a group of persons is associated or took the group of photographs.

While embodiments of the present invention describe context as defining dates, locations, or personal identity, other embodiments of the present invention are well suited to supporting additional contexts, both existing and future contexts, within which to define media objects. For example, in one embodiment, the context could be school zones that can be used to search for a particular listing of homes. In another embodiment, the context could be topic information that help group television listings. For instance, context information that define an interest in Italy, and in particular to Tuscany, for a particular media object can be used to search for television program listing related to Tuscany.

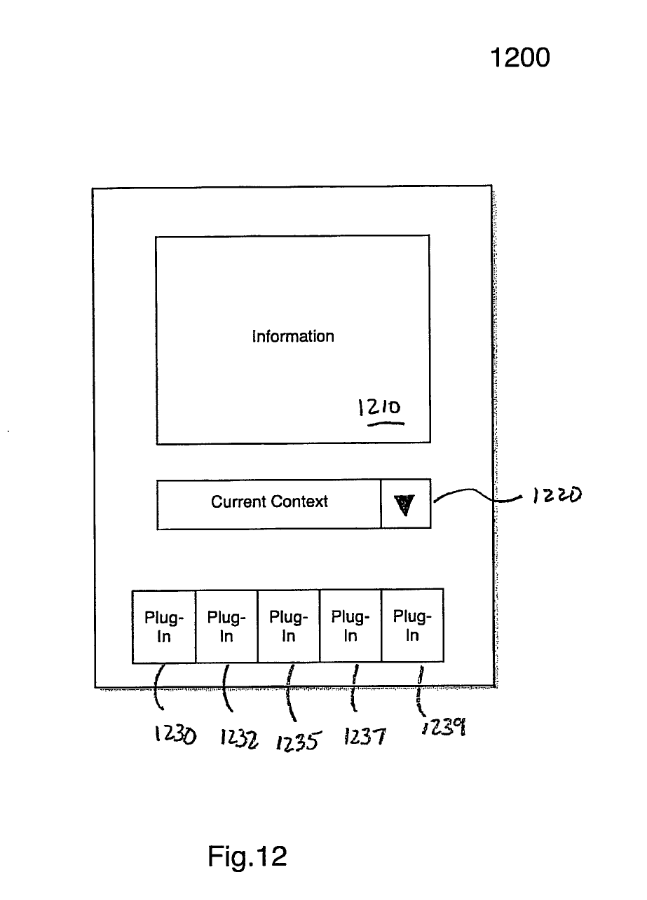

FIG. 12 is a diagram illustrating a display window 1200 showing the implementation of the plug-in application on a media object for a particular context, in accordance with one embodiment of the present invention. As shown in FIG. 12, the window 1200 includes a window 1210 that displays the information generated by a particular plug-in application. A list of plug-in applications supported by a main application is provided at the bottom of the window 1200. For instance, the plug-in applications 1230, 1232, 1235, 1237, and 1239 provide extended functionality to the main application. The information in window 1210, as an example, can be generated by plug application 1230.

Also shown in FIG. 12 is an indication of the current context used by the main application and the plug-in application 1230 that is used to generate the information in window 1210. for instance, for media objects that are photographs, a time in which a photograph or group of photographs were taken can define the current context.

In one embodiment, a navigation selection is provided that allows the current context to be changed to a second context. For instance, in FIG. 12 the drop down button 1270, as an exemplary navigation selection 1270, when invoked can provide a list of contexts available to the main application and each of the plug-in applications 1230, 1232, 1235, 1237, and 1239. As a result, when a second context is selected, the interface is capable of sharing the second context with the main application and each of the plurality of plug-in applications, so that the main application and each of the plurality of plug-in applications can respond to the media object under the second context.

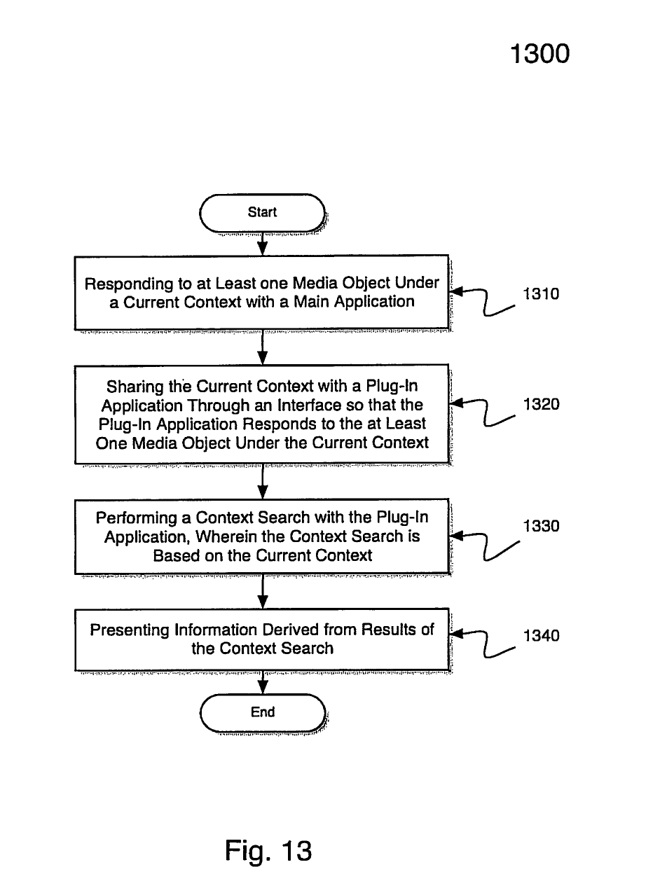

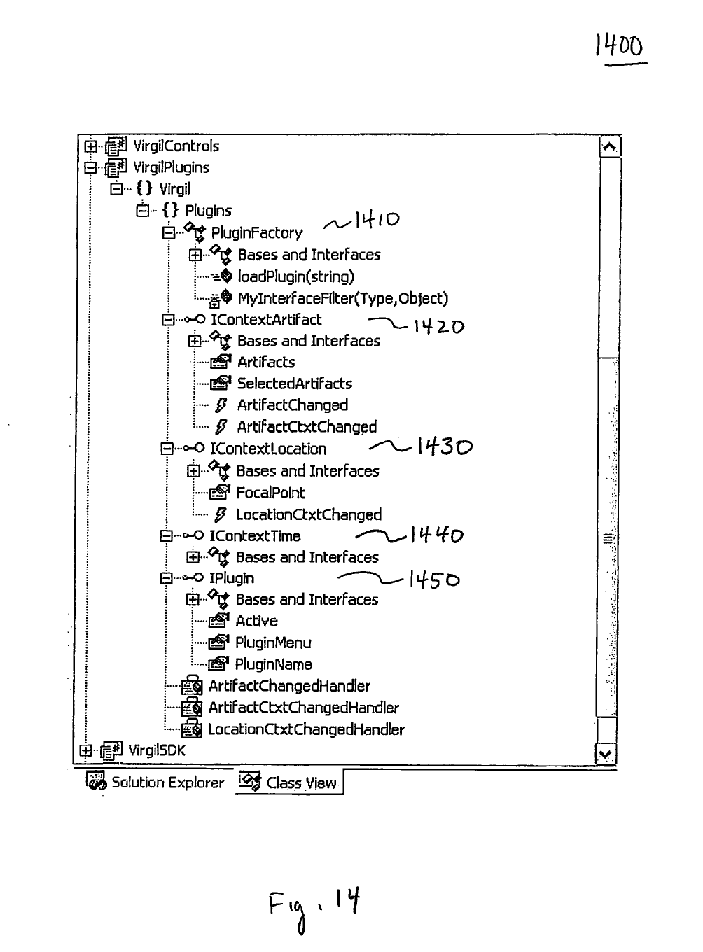

FIG. 13 is a flow chart 1300 illustrating steps in a computer implemented method for extending a context-sensitive plug-in architecture, in accordance with one embodiment of the present invention. The method of the present embodiment utilizes the context-sensitive plug-in architecture as described in FIG. 11 for third party developers to extend the functionality of a main application, such as an information browser application. In addition, the method of the present embodiment utilizes the core management of context (e.g., time, location, and personal identity) to generate related information through each of the plug-in applications in the plug-in architecture.

At 1310, the present embodiment responds to at least one media object under a current context with a main application. As an example, the media object is one or more related photographs. In this case, the main application is an information browser (e.g., photo browser) that stores, arranges, and presents a collection of photographs. In one embodiment, the main application may or may not use the current context when presenting the photographs. However, the current context is either inherently or extrinsically provided in association with the media object.

At 1320, the present embodiment shares the current context with a plug-in application through the interface. In addition, if there are multiple plug-in applications, the present embodiment is able to share the current context with each of the plurality of plug-in applications. As such, the plug-in application, and each of the plurality of plug-in applications are able to respond to the at least one media object under the current context. In that way, each of the plug-in applications are able to utilize the current context to provide additional information related to the media object.

At 1330, the present embodiment performing a context search with the plug-in application. In particular, the context search is based on the current context. For example, in the case where the main application is a photo browser, a location associated with a particular photo or group of photos defining the media object defines the current context. The operation at 1330 is similar to the operation in 100 of FIG. 7.

At 1340, the present embodiment presents the information derived from results of the context search. For instance, using the previous example discussed above, for a location context, a mapping plug-in application may provide 2-dimensional or 3-diemnsional views of the location associated with the media object.

Additionally, in another embodiment of the present invention, the current context is shared with a second plug-in application through the interface. In this way, the second plug-in application is able to respond to the at least one media object also under the current context. In particular, a context-sensitive search is performed with the second plug-in application. In one embodiment, a context-sensitive search is performed with the second plug-in application based on results of the context search in 1330. This operation is similar to the operation 102 of FIG. 7. In another embodiment, a context-sensitive search is performed with the second plug-in application based on information (e.g., metadata) obtained from the media object. In both cases, the resulting information derived from the results of the context-sensitive search are presented.

In another embodiment, the current context as provided to the plurality of plug-in applications is changed from the current context to a second context. The second context is associated with the at least one media object and can be used to provide additional information related to the media object through the use of plug-in applications. More particularly, the second context is shared with each of the plurality of plug-in applications through the interface so that a selected plug-in application is capable of responding to the at least one media object under the second context. As a result, the present embodiment through the interface is able to share the current context, and share any changes (e.g., the context) that is initiated by the main application, the plug-in application selected, or by extension, any other plug-in applications. As a result, the present embodiment allows a user to navigate through time, location, and persons as identified by personal identity context information, and switch between different plug-in applications while changing a state of context.

FIG. 14 is a diagram of a window 1400 illustrating the implementation of plug-in applications within a main application through an interface, in accordance with one embodiment of the present invention. As shown in FIG. 14, classes are defined that implement the various Iplug-in interfaces. In particular, the Plugin Factory 1410 dynamically loads the plug-in DLLs, in one embodiment. In other embodiment, other means are used by the main application to load the plug-in applications. In another embodiment, the plug-in applications are located on remote computing devices, but are still accessible to the main application via the plug-in interface. The IPlugin interface 1450 provides information related to each of the plug-in applications. For instance the main application is able to query the IPlugin interface 1450 to determine the name of the plug-in application and to access the PluginMenu. In one embodiment, the PluginMenu is incorporated into the menu of the main application. In addition, the IcontextArtifact 1420, the IcontextLocation 1430, and the IcontextTime 1440 interfaces provide context definitions and operations that are used by the various plug-in applications. For instance, the context interfaces 1420, 1430, 1440 may include hooks that define actions, operations, and information implemented by each of the plurality of plug-in applications.

Accordingly, embodiments of the present invention are able to provide for a context-sensitive architecture that extends the functionality of a main application. Other embodiments of the present invention provide the above accomplishments and further provide for interfaces which leverages the core management of context throughout the plug-in architecture so that the main application and a plurality of plug-in applications can share a particular context for providing information.

While the methods of embodiments illustrated in processes of FIGS. 7 and 13 show specific sequences and quantity of steps, the present invention is suitable to alternative embodiments. For example, not all the steps provided for in the method are required for the present invention. Furthermore, additional steps can be added to the steps presented in the present embodiment. Likewise, the sequences of steps can be modified depending on the application.

The embodiments that are described herein enable users to serendipitously discover information related to media objects in their collections. In particular, these embodiments automatically obtain information related to one or more selected media objects by performing targeted searches based at least in part on information associated with the selected media objects. In this way, these embodiments enrich and enhance the context in which users experience their media collections.

The preferred embodiment of the present invention, a system and method for a context-sensitive plug-in architecture that is extensible, is thus described. While the present invention has been described in particular embodiments, it should be appreciated that the present invention should not be construed as limited by such embodiments, but rather construed according to the below claims.

What is claimed is:

1. An extensible plug-in architecture, comprising:
a main application responding to at least one media object under a current context;
a plug-in application for extending capabilities of said main application; and
an interface for sharing said current context with said plug-in application so that said plug-in application responds to said at least one media object under said current context.

2. The extensible plug-in architecture of claim 1, wherein said main application comprises a information browser application.

3. The extensible plug-in architecture of claim 2, wherein said main application comprises a photo browser application.

4. The extensible plug-in architecture of claim 1, wherein said current context is taken essentially from a group consisting of:
a time period;
location; and
personal identity.

5. The extensible plug-in architecture of claim 1, wherein said interface provides for compatibility between said main application and said plug-in application.

6. The extensible plug-in architecture of claim 1, further comprising:
a navigation selection for changing said current context to a second context, wherein said interface is capable of sharing said second context with said plug-in application so that said plug-in application responds to said at least one media object under said second context.

7. The extensible plug-in architecture of claim 1, further comprising:
a second plug-in application for extending capabilities of said main application, wherein said interface is capable of sharing said current context with said second plug-in application so that said second plug-in application responds to said at least one media object under said current context.

8. The extensible plug-in architecture of claim 1, wherein at least one of said plurality of plug-in applications is located on a remote device in a distributed plug-in architecture.

9. An extensible plug-in architecture, comprising:
an information browser application responding to at least one media object under a current context;
a plurality of plug-in applications for extending capabilities of said information browser application; and
an interface for sharing said current context with said plurality of plug-in applications, so that each of said plurality of plug-in applications responds to said at least one media object under said current context.

10. The extensible plug-in architecture of claim 9, wherein said current context is taken essentially from a group consisting of:
a date and time;
location; and
personal identity.

11. The extensible plug-in architecture of claim 9, wherein said interface provides for compatibility between said information browser application and said plurality of plug-in applications.

12. The extensible plug-in architecture of claim 9, wherein one of said plurality of plug-in applications comprises a search engine for providing related information from the internet.

13. The extensible plug-in architecture of claim 9, wherein one of said plurality of plug-in applications comprises a mapping capability for mapping a location associated with said at least one media object.

14. The extensible plug-in architecture of claim 9, further comprising:
a navigation selection for changing said current context to a second context, wherein said interface is capable of sharing said second context with said plurality of plug-in applications so that each of said plurality of plug-in applications responds to said at least one media object under said second context.

15. A method of extending a plug-in architecture, comprising:
responding to at least one media object under a current context with a main application;
sharing said current context with a plug-in application through an interface so that said plug-in application responds to said at least one media object under said current context;
performing a context search with said plug-in application, wherein said context search is based on said current context;
presenting information derived from results of said context search.

16. The method of claim 15, further comprising:
sharing said current context with a second plug-in application through said interface so that said second plug-in application responds to said at least one media object under said current context;
performing a context-sensitive search with said second plug-in application based on results of said context search; and
presenting information derived from results of said context-sensitive search.

17. The method of claim 15, further comprising:
changing said current context to a second context that is associated with said at least one media object; and
sharing said second context with said plug-in application through said interface so that said plug-in application responds to said at least one media object under said second context.

18. The method of claim 16, further comprising:
changing said current context to a second context that is associated with said at least one media object; and
sharing said second context with said second plug-in application through said interface so that said second plug-in application responds to said at least one media object under said second context.

19. The method of claim 15, wherein said responding to at least one media object further comprises:
responding to said at least one media object under a current context with said main application that comprises an information browser application.

20. The method of claim 15, wherein said sharing said current context further comprises:
sharing said current context with said plug-in application that is remotely located in a distributed plug-in architecture.

21. A computer system comprising:
a bus;
a memory unit coupled to said bus; and
a processor coupled to said bus, said processor for executing computer executable instructions in a method of extending a plug-in architecture, comprising:
responding to at least one media object under a current context with a main application;
sharing said current context with a plug-in application through an interface so that said plug-in application responds to said at least one media object under said current context;
performing a context search with said plug-in application, wherein said context search is based on said current context;
presenting information derived from results of said context search.

22. The computer system of claim 21, wherein said method comprises additional instructions, which when executed effect said method of extending a plug-in architecture, said additional instructions comprising:
sharing said current context with a second plug-in application through said interface so that said second plug-in application responds to said at least one media object under said current context;
performing a context-sensitive search with said second plug-in application based on results of said context search; and
presenting information derived from results of said context-sensitive search.

23. The computer system of claim 21, wherein said method comprises additional instructions, which when executed effect said method of extending a plug-in architecture, said additional instructions comprising:
changing said current context to a second context that is associated with said at least one media object; and
sharing said second context with said plug-in application through said interface so that said plug-in application responds to said at least one media object under said second context.

24. The computer system of claim 22, wherein said method comprises additional instructions, which when executed effect said method of extending a plug-in architecture, said additional instructions comprising:
changing said current context to a second context that is associated with said at least one media object; and
sharing said second context with said second plug-in application through said interface so that said second plug-in application responds to said at least one media object under said second context.

25. The computer system of claim 21, wherein said instructions for sharing said current context further comprises additional instructions which, when executed effect said method for extending a plug-in architecture, said additional instructions comprising:
sharing said current context with a plug-in application that is remotely located in a distributed plug-in architecture.

26. A computer-readable medium storing computer-readable instructions that when executed effect a method of extending a plug-in architecture, comprising:
responding to at least one media object under a current context with a main application;
sharing said current context with a plug-in application through an interface so that said plug-in application responds to said at least one media object under said current context;
performing a context search with said plug-in application, wherein said context search is based on said current context; and
presenting information derived from results of said context search.
